(19) United States
(12) Patent Application Publication
(10) Pub. No.: US 2014/0275418 A1
(43) Pub. Date: Sep. 18, 2014

(54) Method and substrate for covalent attachment and encapsulation of biological, chemical and physical substances

(71) Applicant: Hristem Mitkov Dyanov, Niles, IL (US)

(72) Inventors: Hristem Mitkov Dyanov, Niles, IL (US); Paoula Hristemova Dyanova, Skokie, IL (US)

(73) Assignee: Hristem Mitkov Dyanov, Niles, IL (US)

(21) Appl. No.: 14/210,417

(22) Filed: Mar. 13, 2014

Related U.S. Application Data
(60) Provisional application No. 61/786,261, filed on Mar. 14, 2013.

(51) Int. Cl. C09D 5/00

(52) U.S. Cl. CPC C09D 5/00
USPC 524/858

(57) ABSTRACT

The invention describes methodological approach for preparation of variable compositions of multi-component derivatization mixtures containing silanes, cyclic molecular compounds (silanes, hydrocarbons, silane-carbons and their derivatives) and other molecular components with certain repellant- and optical properties (as separate molecular substances or as molecular substitutes within the silanes and/or the cyclic compound molecules). Such methodological approach offers better flexibility for water-repellant mixtures preparation in achieving high water-repellant (hydrophobic) properties, durability and long-lasting (permanent) bonding for specific surface applications and for preparation of other subsequent types of repellant, attachment and impregnation compositions used serve practical biological, mechanical and/or industrial purposes.

### CROSS-REFERENCE TO RELATED APPLICATIONS

This application is claiming the priority benefit of the provisional patent application U.S. 61/786,119 “Method and substrate for covalent attachment and encapsulation of biological, chemical and physical substances”.

### TERMINOLOGY AND ABBREVIATIONS USED

Halogen-substituted silane means a silane molecule containing silicon (Si) atom(s) covalently bound with 1, 2, 3 or 4 of any of the halogen-elements from the Periodic Table such as Chlorine (Cl), Fluorine (F), Iodine (I) and Bromine (Br) at a particular single silicone atom—a minimum of one and more (up to all) silicon atom(s) may be bound to halogen atom(s). Within the description of this invention as required by the chemical principles, a maximum of 4 halogen atoms are allowed to be covalently bound at each one silicone (Si) atom therefore the total number of halogen-atoms within a silane molecule may be higher than 4; i.e. depending upon the total number of silicone atoms within the particular silane molecule of choice and the molecular structure of the molecule. The same requirements are valid for the carbon atom within carbon-silanes, hydrocarbons and their chemical derivatives—i.e. halogenated carbons and halogenated carbon-silanes (carbo-silanes).

Silane in general means any substance with molecule containing at least one silicone (Si) atom. The description “silicones” for the whole class of polysiloxanes is an imitation of the oxygen-carbon bonds of carbon chemistry which are known as “ketones”. (The latter however, because of their particular characteristics, form double bonds instead of single bonds)

Nanolayer and microlayer: The words “nano” and “micro” refer to the metric scale of measurements as defined by the international SI system. In more general meaning for the purpose of this invention the “nanolayer” and “microlayer” are used to as to refer to a very thin surface layer composed by molecular-size components—usually not exceeding microns-size thicknesses.

All chemical terminology used is according to the widest-possible meaning as accepted within the common chemical practice and terminology and closely matches the UPAC nomenclature.

### FIELD OF THE INVENTION

This invention relates to thin-layer coating compositions which have high application flexibility, relatively low toxicity, produces a highly durable solids- and semi-solids coating, and has an improved external appearance, curability, and long-lasting properties achieved by permanent-type bonding. More particularly, the invention relates to a curing composition useful as a finishing coating composition for surface-deposition and -derivatization with highly active chemical groups serving for subsequent substitution and attachment of desired chemical, bio-chemical and nano-sized solids thereby serving as a bonding agents to metal, plastic and biological surfaces, glass surfaces, and used in applicable fields including but not limited to biological objects, bio-array preparation technology, 3-dimensional micro-casting and material encapsulation for phase separation or surface derivatization, and for designing optical properties such as but not limited to light-channeling micro-fiber affects and cloaking effects.

### BACKGROUND OF THE INVENTION

In the past 20-30 yeas silane chemistry is one of the highly developing areas of the modern chemical industry applicable to wide areas of world economy—from fundamental chemistry and construction industry to microelectronics and bio-microarray technology. As a result extremely wide varieties of silane- and carbon-silane chemicals have been produced serving for wide variety of purposes and applications. Many of them are used for the preparation of different repellant surfaces, generally—water- or oil-repellant. Variety of patents has been filed to support such discoveries. Nevertheless, universal approach has been to produce silane-containing compounds including single-type silanes or silane-containing substances exhibiting both certain desired physical- and chemical properties, and different levels of chemical structure complexity. For example almost any sealant or paint product includes cyclic silanes as additives—used as a repellant—or shine contributor; which, however, are (as is) incapable of creating effective nano-layers when not cross-reacted with other—chemically-active silane(s). Although this common type of approach had successfully resulted in the global development of silane chemistry and industry, producing inexpensive compounds with complex and efficient properties for use in wide variety of applications could be achieved by a novel, very flexible, easy and low-cost approach of combining (mixing) two or more silane-containing chemicals capable of pre-and/or post-reacting with each-other and/or with the target surfaces upon their final application. This approach of “assembling properties” in situ by combining multiple silane- (alone) and multiple silane- & non-silane chemicals, rather than “designing & chemically synthesizing” specialized chemical substances (silanes), is extremely benefiting from any point of view.

### SUMMARY OF THE INVENTION

The invention describes methodological approach for preparation and utilization of variable compositions of one-, two- and multi-component solutions containing variety of halogenated silanes, cyclic molecular compounds (silanes, hydrocarbons, silane-carbons and their derivatives) and other hydrophobic or hydrophilic molecular components (in a form of separate molecular substances or as molecular substitutes within the silanes and/or the cyclic compound molecules).

The essential parts of this invention are:
The approach of mixing one or more chemical compounds thereby exploring both—first, the combinatory approach of designing properties rather than chemical design with synthesis of a particular single molecular monomer substances and, second, the combinatory approach of “in-situ” (on-the-place) assembling of properties immediately upon combining all components and immediately after applying the combinatory solutions (mixtures) onto the applicable surfaces as minimal and/or significant chemical reaction arrangements may occur during both conditions (i.e. the mixing and the surface deposition).
The approach of combining multiple-type halogen-element-substituted, azido-group-substituted, 3-Mercaptopropyl-group-substituted, acetylene-group-substituted and fluoromethanesulfonate-group-substituted monomers' chain-molecules containing the both highly hydrophobic (water-repellent) chemical elements—Silicon (Si) and Carbon (C)—thereby achieving two significant properties—first, the halogen-element and the other-types of chemical groups are highly (violently) reactive with almost all other chemical elements and substances which makes them the perfect choice for universal polymerization- and surface-bonding agents that in low molecular proportions as used are relatively harmless the environment, the surfaces of attachment and the derivatization molecules. Second, the particular choices of compounds (depending upon a particular design features) with particular number and type of halogen-atoms (or other above-mentioned chemical groups) and their positions within the monomer molecular chain allows for designing the following: the density-, the thickness-, the levels of hydrophobicity (water-repellency), the bonding strength and other physico-chemical properties of the resulting surfacing layers.
The approach of combining not only the ability of covalent (strongest-possible) attachment bonding to the applicable surfaces via halogen element reaction substitution, but also the very-high adsorption capabilities (properties) of both the silicone (Si) and the carbon (C) atoms, as well as the optical clarity of the predominantly silicone-containing layers are desired and can be designed within specific applications. The combinatory variations of employing both Si- and C-atomic properties within one- or separate monomer substances allows for optimization between the higher optical clarity of the Silicone- and the higher hydrophobicity but relatively lower optical transparency of the Carbon-containing surface layers.
The approach of utilizing cyclic Silicon- and Carbon-containing monomer substances with relatively low molecular size allows for increasing the density of the hydrophobic layers created combined with the ability to control the thickness of the layers created since the cyclic molecules are more compact (2-dimentional) in size and (if non-substituted) are less-capable of “branching” when polymerizing and forming the final coating layer.
The approach of utilizing compounds with prevailing Silicone-atom content rather than carbon-containing led to a remarkable observation of light-channeling properties of the created surface layers that led to reduced surface light-diffraction observed as optical “disappearance” of light-diffraction from scratches and imperfections on optical lenses as well as microscopically observed micro-fiber-like effects of light-channeling allowing for internal illumination of colored microscopic preparations. Therefore, many silicone-rich solutions (mixtures) prepared via the methodological approach described in this invention are applicable in optical and light-cloaking implementations as well as in optical- and electromagnetic microscopic detection of signal molecules attached on micro-surfaces.

Such methodological approach offers better flexibility for surface attachment and encapsulation, water-affinity or hydrophobic properties, durability and long-lasting (permanent) bonding for specific surface applications and for preparation of other subsequent types of repellant- or affine surfacing solutions such as paints or sealing agents, textiles and else.

### DESCRIPTION OF THE DRAWINGS

In the drawings, which form a part of this specification, are presented in the following:

FIG. 1: Schematic representation of the length (size) limitations of the hydrophobic (water-repellent) radical substitutions.

FIG. 2: Example of Silane Polymer Formation Based Upon Hydrolysis Reaction.

FIG. 3: Nano-layer formation and spotting protection test on cellulose and cotton material.

FIG. 4: Encapsulation of HL-60 human lymphocyte cells followed by fluorescent hybridization. White areas correspond to the presence of GMC-SF receptor transcript while the cells with no white areas lack the transcript.

FIG. 5: In vivo encapsulation attachment of D. virilis total organs by solution of 1% of gamma-propylthriethoxy silane and 0.1% thrimethyliodosilane. The silane solution, dissolved in ethanol, was top-sprayed with instant binding and fixation followed by in situ hybridization with PEBme III ejaculatory bulb protein cDNA and enzymatic staining.

FIG. 6: Attachment of DNA oligonucleotides on glass slide surface. Several 3 mm spots were performed with the same Cy-3 labeled 17-mer oligonucleotide onto glass slides derivatized with 3 different 2% silane solutions: solution 1—Trimethyliodosilane; solution 2—Azidotrimethylsilane; Solution 3—Triethylsilyl acetylene. Slides were scanned before and after washing.

FIG. 7: Oligonucleotide attachment and cDNA hybridization on nylon membrane attached onto glass-slide surface by a mixture of Trimethyliodosilane (10%) and Decamethylcyclopentasiloxane (90%).

FIG. 8: Direct oligonucleotide attachment onto silane-modified glass by micro-printing (0.05-0.1 mm spots) with Lucidea spotting robot.

FIG. 9: Protein attachment and biotin-streptavidin attachment reaction on glass slides derivatized with azidotrimethylsilane. Biotinylated anti-streptavidin antibodies were attached onto glass slides. The top image represents phycoerythrin- (fluorescent-dye) labeled SAPE bound to unwashed Biotinylated anti-streptavidin antibodies and the bottom image represents the binding to the washed slides. The actual images are the vertical ones to the left and the 3-D graphic distribution of the signal is shown to the right of each slide image.

FIG. 10: Testing surface repellency on different commercially important materials treated with surfacing mixtures.

### DETAILED DESCRIPTION OF THE INVENTION

The present invention will be described in further detail herein below.

The invented approach explores the ability of single-, double- and multi-halogen-element-substituted (shortly: “halogen-substituted”) silanes and silanes with highly reactive chemical groups such as azido-, acetylene-, mercapto-, sulfonate-, thiol-, methoxy-, methacryloxy-, and else (including, but not limited only to, any alkyl-, aryl- and cyclic-silanes) to form both: poly-condensates (carrying certain quantities of repellant chemical groups) with other chemicals (silanes, organosilanes, carbohydrates, etc.) and to form violently-fast covalent bonds with almost any surface molecules of the substances applied on/to (because of the high reactivity of the halogen atoms) resulting in the formation of 2- or 3-dimensional nano-layers exhibiting designed-level of hydrophilic-, hydrophobic or bi-polar properties depending upon the type and the position of molecular substitutes chosen within the silane molecules. The absorption (adherence) capabilities of the Si-atom also contribute to the surface attachment formation. Some examples of halogen-substituted silanes used in pilot-testing the described here invention are: chlorotrimethylsilane, dichlorodimethylsilane, methyltrichlorosilane, dichloro-methylphenylsilane, phenyldichlorosilane, dichlorodiphenylsilane, octadecyltrichlorosilane, 1,7-dichlorooctamethyl-tetrasiloxane, 3,5-dichloroocta-methyltetrasiloxane, trimethylsilyl azide (azidotrimethylsilane), triethylsilyl trifluoromethanesulfonate, triethylsilyl acetylene and (3-mercaptopropyl)-trimethoxysilane (3-trimethoxysilyl-1-propanethiol).

By creating combinatory mixes of halogen-substituted silanes and other silanes, siloxanes, hydrocarbons and else exhibiting hydrophobic (water-repellent) properties, highly efficient water-repellent micro-thin surfaces are produced instantly when the mixtures are deposited as surfacing layer(s) via variety of derivatization approaches (spraying, mixing, evaporation, vacuumization, etc.). Varying the molecular ratios of the 1-, 2-, 3- or 4-halogen- and/or other-type of substituted (at a single silicone atom) silanes allows for adjusting the thickness and the density of the created nano-layers—i.e. (in the mixture) the higher the molecular ratios of the halogen-substituted silanes are, the higher is the thickness and the density of the resulting nano-layer formation. Also, the longer the hydrocarbon- (or other hydrophobic-) molecular chains of the substitutions at each silicone (Si) atom is—the higher is the thickness and the density of the resulting nano-layer; respectively—the greater is the hydrophobicity (water-repellency).

For the purpose of this invention, the length of each hydrophobic-chain substitution (at a silicone atom) is limited to a maximum 300 atoms [represented by “A” on the FIG. 1]—connected in a “straight” chain, not including side-groups (tertiary-, quaternary-[marked as “G”]); i.e. substitution chain of a type as in the FIG. 1. The size of these hydrophobic chains is of particular significance when hydrophobic properties has to be created on surfaces with large gaps between the structure-supportive materials—the larger the hydrophobic chains of the Si-substitutions are, the larger gaps can be filled-in (see FIG. 3, the cotton napkin image).

The most important (claim 6) in this invention is the idea of applying the approach of mixing different compositions of silanes and siloxanes (in molecular ratios of mixed chemicals ranging from 0.001% to 99.999% between each-other—prior to their application onto the treated surfaces in order to compose the appropriate water-repellent properties (depending upon highly- or less-specific surface applications), rather than chemically designing and synthesizing single silane molecular structures alone—in order to employ similar to the above-mentioned repellant, attachment-active, encapsulation, optical and else properties. This approach allows for great flexibility in designing variations of different applications for variety of surface types. According to the invention, the composed polymer-preparation mixtures contain one, two or more of the components as follows: Components Type-1—silane substituted with 1, 2, 3, or 4 of the following—highly-reactive halogen atoms (such as F [fluorine], Cl [chlorine], I [iodine] and Br [bromine]) and/or the following chemically volatile (highly-reactive) chemical groups: azido-, acetylene-, mercapto-, sulfonate-, thiol-, methoxy-, methacryloxy-—at one-, more- or all silicone (Si) atoms of the halogenated silane molecule or at any other position of a particular molecule—in accordance to the common chemistry principles. For clarification, from one up to four halogen-substitutions are allowed at at-least one silicone or carbon atom, however as maximum as all silane atoms in a particular halogen-silane molecule may be substituted with halogen atoms as a matter of particular choice according to the general chemistry principles. More than one type of silanes chemically substituted with highly-reactive molecules may be used in each particular mixture depending upon particular applications. Preferable, but not the only matter of choice are silanes with 2- and/or 3 halogen substitutions per single molecular structure and at least one hydrophobic-group substitution such as alkyl-, aryl-, or else. The chemical formula for the substituted silanes used as a Components Type-1 is schematically represented by Xₙ—[Si]—Rₘ, where “R” is preferably an alkyl group having from 1 to 300 carbon atoms per R-radical, such as methyl-, ethyl-, n-propyl-, isopropyl-, n-butyl-, sec-butyl-, decyl-, dodecyl-, tetradecyl-, hexadecyl-, octadecyl-, etc. radicals. Examples of aryl groups represented by R are phenyl- and toloyl radicals. Examples of alicyclic groups represented by “R”, which are free of heteroatoms as constituents of the ring are —(CH₂)₅— and —(CH₂)₄— radicals, and an example of alicyclic groups represented by “R” which have a heteroatom as a constituent of the ring is a —(CH₂)₂—O—(CH₂)₂— radical. The methyl-radical is a preferred example of an alkyl group represented by “R” and the chlorine is a preferred example of the halogen elements represented by “X” where “X”-substitution represents any of the following reactive chemical groups—halogen-, azido-, acetylene-, mercapto-, sulfonate-, thiol-, methoxy-, methacryloxy-; “n” and “m” corresponds to the total number of substitutions containing “n” reactive groups (atoms) and “m” hydrocarbons (alkyl-, aryl-, alicyclic- or else groups). “[Sil]” in the formula stands for “silane” in which one or more silicone (Si) atoms are present within the silane molecule and each of them may be substituted; for the purpose of this invention silanes with any chemical structure can be used containing from 1 to 300 silicone atoms within a single silane and/or carbon-silane (organosilane) molecule. Components Type-2—cyclic silane, siloxane, hydrocarbon and/or their derivatives. The role of the cyclic molecules is to allow for creating higher nano-layer densities and a preferable layer growth in one dimension (i.e. enhanced 2-dimensional growth—in parallel of the surface applied on) rather than equal growth in all 3 dimensions. Another, Components Type-3, (applicable but not obligatory) also may be employed as been any other chemical substance exhibiting certain hydrophobic molecular properties and/or high affinity to react and substitute a halogen element from the silane molecule; some (but not only) examples of the latest are —H, —OH, C═C, C≡C, Metal-containing molecules and others. As an additional Components Type-3 type are used so-called composite carriers. Preferred nano(micro)-layer composite carriers which are relatively insoluble in the reaction medium are, for example, substances having hydroxyl groups on their surface capable of reacting in a strong manner with the halogenated silanes creating nanolayer composites. Examples of such substances are biological molecules and substances, acidic clays, such as for example Tonsil, montmorillonite and other aluminosilicates in the H⁺-form, zeolites, non- or porous glass (such as, for example, controlled pore glass), non- or porous ceramics (such as controlled pore ceramics), non- or porous silicon dioxide (such as precipitated or pyrogenic silica), non- or porous alumina and non- or porous mullite. Additional examples of preferred carriers which are insoluble in the reaction medium are dried hydrolysis products of functional silanes or polystyrenes, such as, for example, polystyrene which is cross-linked with divinylbenzene. Components Type-3 could itself be a multi-component mixture.

The invention's main core is the process for forming a silicon film on the surface of a substrate comprising the approach of preliminary preparation of single- or multi-component mixes containing at least one silicone component substituted with highly-reactive chemical group (as above-mentioned), which serves a highly important feature within the repellent layer when first surface-deposited and contacted with the air-born water humidity and/or water condensation: The spontaneous reaction of the monomer (organo)halogen-silanes with water molecules or hydroxyl groups (hydrolysis) [i.e. solvent-alcohol(s) or else—when used] produces silanols, which, using HCl catalysis, lead directly to further reacted oligomers or polymer siloxanes completing the repellant layer formation via directed- (designed-) (FIG. 2) and/or random chemical reactions. Another oxidation-reduction substitution reaction other than the hydrolysis can also be utilized. This process includes the approach of preliminary (initial) molecular distribution and interactions of the silane components (halogenated and cyclic) in the pre-mixed solutions (mixtures) as well as the absorption (adherence) properties of the Si-atom which all contribute to the surface attachment formation of the nano-layers bearing water-repellent (hydrophobic).

### Chemical Processes Behind the Repellant Nano-Layer Formation

The invented approach of initial pre-treatment preparation of multi-component mixes containing at least one halogenated silicone component serves as a highly important feature (as described) within the repellent layer when first surface-deposited and contacted with the water humidity from natural sources (humidity, rain, etc.): in particular cases, the spontaneous reaction of the monomer (organo)halogen-silanes with water (hydrolysis) [or applicable solvent-alcohol(s)] produces silanols, which, enhanced by HCl catalysis, lead directly to further reacted oligomers or polymer siloxanes completing the repellant layer formation (in the picture “Si” represents silicon, “O” stands for oxygen). The description “silicones” for the whole class of polysiloxanes is an imitation of the oxygen-carbon bonds of carbon chemistry which are known as “ketones”. (The latter however, because of their particular characteristics, form double bonds instead of single bonds); (FIG. 2).

Mono-, di-, tri- or tetrafunctional siloxane units with Si—O bonds arise from polycondensation according to the number of chlorine atoms of the basic silane molecule. In the chemical industry, the diverse halogenated silanes serve as building blocks for the synthesis of the various types of silicones such as fluids, resins and nano-layers.

In our test-experiments, the halogen-substituted alkyl-silanes enable the formation of longer Si—O chains while carrying out hydrophobic properties. At first the hydrolysis of, for example, dimethyldichlorosilane gives a mixture of short chained, di-functional and therefore linear siloxanes with OH and groups as well as cyclic siloxanes having normally between three and fifteen chain units. The linear siloxanes show a helix structure with the methyl groups being freely able to rotate. All silicone fluids, emulsions and rubbers are based on dimethyldichlorosilane. This is therefore the decisive base product for the industry. Within our test combinations the halogenated-silane polycondensation interacts with the cyclosilane component in the mixture enhancing the nano-layer formation via direct substitution reactions and/or cyclic concatenation.

If the trichloro- (respectively, tri- or four-halogen-substituted) silane compounds are used, a cross-linking between the linear chains is produced as a result of the three- or four reactive sites of silicon atom. A three dimensional polymer network is the consequence. This process is crucial in the formation of silicone resins and thicker dense nano-layers.

Mono-chlorosilanes, on the other hand, because of their single reactive site, can be used predominantly for the terminating of the chain growth by polycondensation and for very limited single-molecule thickness of the resulting nano-layer. They react as a sort of “capping agent” for the growing silicone chain. Increasing their relative ration within a composed mixture leads to thinner and low-branched layer formation.

In addition to the simple hydrolysis reaction of halogenated silanes, variations of random halogen-replacement reactions occur in the silane mixtures described in this invention (as common in the Silane Chemistry)—all serving in repellant polymeric layer formation in situ. The particular variation in concentrations (molar ratios) of mono- and multi-halogen silane substitutes, cyclosilanes, hydrocarbons and carbon-silanes allows for best optimization of nano-layer formation as desired by a specific application's design—by taking into account the molecular reactions variations as a result of the molar ratios variations of the mixture components.

### Preparing and Deploying Proof-of-Concept Testing of Silane Solution Mixes

### Experiment-1

Test Conditions Specified amounts of silanes' solution mixtures (from the bottled solutions as numbered above) were center-spotted in the amounts specified below on a white cellulose paper napkin and on white cotton napkin at the positions specified below (image). A 20-μl Gilson automatic pipetter was used for the deposition of the mixtures. Spotted materials were dried for 20 min at 40° C. and then were completely soaked (immersed) for 30 minutes in a methylene blue/xylene cyanol dye solution in water. Then the dye-solution excess was removed by gently pressing the wet material between a paper-towel for 3 sec. and then air-drying for 30 min at 40° C. Black carbon-pencil mark (“+”) shows the center of the spotting (FIG. 3). The large white spots represent the water-repellent protected areas. Images were taken at 600 dpi on Canon LIDE-20 scanner.

### Prepared Solutions:

| | |
|---|---|
| Solution #1: | 100% Decamethylcyclopentasiloxane [from Oakwood Chemical; Catalog #: S05475] |
| Solution #2: | 90 ml of Decamethylcyclopentasiloxane [from Oakwood Chemical; Catalog #: S05475] + |
| | 10 ml of Dichlorodimethylsilane [from Sigma-Aldrich; Catalog #: 440272] |
| Solution #3: | 90 ml of Decamethylcyclopentasiloxane [from Oakwood Chemical; Catalog #: S05475] + |
| | 10 ml of Methyltrichlorosilane [from Sigma-Aldrich; Catalog #: M85301-100G] |
| Solution #4: | 90 ml of Decamethylcyclopentasiloxane [from Oakwood Chemical; Catalog #: S05475] + |
| | 10 ml of Octadecyltrichlorosilane [from Sigma-Aldrich; Catalog #: 104817-25G] |
| Solution #5: | 90 ml of Decamethylcyclopentasiloxane [from Oakwood Chemical; Catalog #: S05475] + |
| | 10 ml of 1,7-Dichlorooctamethyltetrasiloxane [from Sigma-Aldrich; Cat.#: 384372-25G] |

### Experiment-1 Conclusions:

The experimental result (FIG. 3) clearly evidences that the ability of tri-chloro silanes to create 3-dimensional nano-layers produces a better water-repellant coating and better encapsulation efficiency (positions 2 and 3), successfully entrapping even the large-size (sub-millimeter) spaces existing within the cotton napkin, when compared to the 2-dimensional nano-layer created by the di-chloro silanes (positions 1 and 4 on FIG. 3)—in this experiment all chemically-reactive silanes were cross-combined with the chemically “passive” cyclosilane (decamethylcyclopentasiloxane).

Comparing positions 2 and 3 shows the significant influence of the hydrophobic hydrocarbon chain on the water-repellant properties—i.e. the longer the chain is (position 3) the better the water-repellant protection is. This is better visible and distinguished when the air-gaps between the material support are larger (cotton napkin; right-image) compared to the smaller gaps (cellulose napkin; left-image).

### Experiment 2:

Encapsulation of HL-60 human lymphocyte cells followed by fluorescent hybridization (FIG. 4). Thrimethyliodosilane was used as 1% solution in tholuol for both cell entrapment onto glass slide and for fixing the cell-content including the nucleic acids inside. Both the fixation entrapment and the cell-content fixation sere instant upon contact with the silane solution thereby serving as a perfect preservation method. In situ hybridization on HL-60 human lymphocyte cells stimulated by 10 ng/ml phorbylmyristate acetate (PMA) mounted on glass slide. The hybridization probe was 541-bp PCR fluorescein-dUTP-labeled cDNA fragment of GMC-SF receptor mRNA. White areas (FIG. 5) correspond to the presence of GMC-SF receptor transcript. The silane-mediated entrapment had ensured 100% retention rate, perfect content preservation, perfect chemical and biochemical permeability and ability to store and preserve the material for decades; in our case the material was still present in unmodified conditions after 20 years of storage.

### Experiment 3:

In vivo encapsulation attachment of D. virilis (fruit-fly) total organs by a solution of 1% of gamma-propylthriethoxy silane and 0.1% thrimethyliodosilane in ethanol (FIG. 5). The silane solution was top-sprayed onto the glass deposed with instant binding and fixation followed by in situ hybridization with PEBme III ejaculatory bulb protein cDNA and enzymatic staining. The transcript visualization was generated by an alkaline phosphatase-mediated enzymatic coloring reaction after a hybridization with 485-bp labeled cDNA fragment probe. The method for total organ encapsulation demonstrated several outstanding benefits. First, the microscopic organs (with still vital tissue material) became permanently entrapped within the 2-dimentional nanolayer encapsulation instantly within 1 second while being alive—that is a phenomenal possibility for preserving the entire cellular content as-is to be mage available for study for decades into the future that is virtually beyond precedent. Second the entrapment resulted in 100% retention supported by hundreds of attachment/hybridizations performed being so durable that the tissue preparations were still available intact after 25 years of storage. Third, the nanolayer is chemically inert and perfectly permeably not only for solvents and chemicals but also protein enzymes. Finally, since its extreme durability it offered unlimited handling options for speeding up the entire handling and reaction process by applying rigorous shaking and even routinely-used ultrasound treatment of the preparations.

### Experiment 4:

Attachment of DNA oligonucleotides on glass slide surface.

### Description of the Method:

Slides derivatization: Glass slides were cleaned by incubation in concentrated sulfuric acid for 20 min in ultrasound bath, washed in distilled water, treated with methanol-acetic acid (1:1) for 20 min, washed in 3 changes of deionized water—all in ultrasonic bath—and finally dried. Slides were derivatized with silane by ultasonication for 30 min in 3% silane solution in methanol or acetone or by direct immersion in concentrated silane solution for 5 seconds. Slides and silane solutions were processed in dehumidified chamber where derivatized slides were dried in dark. Slides were stored in dehumidified polyethylene bags in dark until use. Several 3 mm spots were performed (0.25 microlitters of 50 μM Cy3-labelled N₁₄ oligonucleotide were deposed manually) with the same Cy-5 labeled 14-mer oligonucleotide onto glass slides derivatized with 3 different 3% silane solutions: solution 1—Trimethyliodosilane; solution 2—Azidotrimethylsilane; Solution 3—Triethylsilyl acetylene. The attachment of the oligo is instant upon contact. Slides were heated at 60° C. for 30 seconds for complete drying. Slides were scanned before and after wash to remove the unbound oligonucleotide and provide for binding efficiency.

### Experimental Result:

Cy-5 labeled oligonucleotide attachment to the silanated glass-slide surface are provided on FIG. 6. Images on the left are scanned under fluorescent illumination immediately after the oligonucleotide water-solution deposition (1 microliter) and the images on the right are scanned after wash of the non-attached oligonucleotide in excess for 10-times by immersion in deionized water, air-dried and then were scanned again.

In conclusion, after testing 22 different silane we observed that the silanes with highly reactive chemical groups with affinity to hydroxyl groups demonstrated best efficiency. Also in considering the best performers, important feature is the hydrophobicity of the silane layer. Extreme hydrophobicity leads to very-small dots and less-efficient deposition even if the reactivity of the attachment is high leading to a preference of silanes demonstration a low hydrophobicity. Trimethyliodosilane is one of the most reactive silylating agents. Hydroxyl groups are silylated immediately, keto groups yield the pure silyl enol ether within a few min. Slight drawback with this application of MIS is the formation of dehydrated products. This can be avoided by using only very small amounts of catalyst, by protecting from light and by addition of a of primary ammines, especially N,N-bis-(tri-methylsilyl)-cyclohexylamine. The Trimethylsilyl azide (=Azidotrimethylsilane), is known to silylate primary and secondary alcohols and phenols very rapidly and efficiently at room temp. Tertiary alcohols do not react under the reaction conditions employed. The only by-product of this mild silylation method is the gaseous NH₃. Triethylsilyl acetylene was found to be demonstration the third most efficient performance in attaching oligonucleotides.

### Experiment 5:

Oligonucleotide attachment and cDNA hybridization on nylon membrane attached onto glass-slide surface by a mixture of Trimethyliodosilane (10%) and Decamethylcyclopenta-siloxane (90%).

Description of the Method: GeneScreen nylon membrane was attached onto a glass slides by immediate top-deposition on the slide after the slide immersion in a mixture of Trimethyliodosilane (10%) and Decamethylcyclopentasiloxane (90%) and gravitationally adsorbing the solution excess. The membrane is steadily attached right after liquid drying (optionally accelerated by heating for 15-20 min at 60° C. 13-, 15- and 17-mer oligonucleotides were robotically deposited onto the membrane by 0.3 mm pin-array and Beckman Biomek 2000 spotting robot (3 repeated spotting per dot). Cy3-labeled cDNA target from mouse kidney was hybridized onto two arrays and the array were scanned immediately after concluding the hybridization and after wash for 40 minutes at 65° C. in 7% Lauroyl sarcosine, 1% SDS with shaking.

Experimental Result and Conclusion: The membrane retention to the glass was superior even after the extremely harsh washing conditions. The result is presented on FIG. 7.

### Experiment 6:

Direct oligonucleotide attachment onto silane-modified glass by micro-printing (0.05-0.1 mm spots) with Lucidea spotting robot.

Description of the Method: Cy3-labeled oligonucleotide and Cy3-deoxynucleotide attachment onto glass slide by micro-drop deposition by using Lucidea spotting robot. On the top rows of each slide we deposed 3× to 30× diluted 50 μM Cy3-labelled N₁₄ oligonucleotide in water-solution of 40 μM herring sperm DNA shredded to a 17-mer size. On the bottom rows of each slide was deposed 1 μM water-solution of Cy3-dUTP. Lucidea spotting robot (Amersham-Pharmacia Biosciences) was used for spotting on 10 slides with unpolished surfaces derivatized with 100% Trimethyliodosilane and another 10 slides were derivatized with Azidotrimethylsilane. Slides were heated for 30 seconds at 60° C., scanned, washed by 10-times immersion in water, dried and scanned again to calculate the remaining attached (oligo)nucleotide.

Experimental Result and Conclusion: (1) Iodotrimethylsilane offers quick and efficient derivatization of solid substrates for nucleic acid attachment without any other treatment. The oligonucleotide attachment is superior to any other known method or glass-derivatized surface except direct chemical synthesis by laser photo-patterning. (2) Heating at 50-70° C. improves the attachment. (3) Because of the glass-slide surface discrepancies, both nucleic-acid's deposition and attachment are highly variable across the slide and among the slides. For elimination of this problem, silicon wafers or metal-monolayer-derivatized slides are recommended for microarray preparation instead of regular microscopic glass-slides or slides must be finely polished. (4) The significantly higher signal saturation of the single-nucleotide labeled dots compared to the lower-intensity of the oligonucleotide dots is due to the fact that each dUTP molecule is attached to the Cy3 fluorochrome, while only one nucleotide of the 14-nase oligo is attached to a Cy3 molecule. Results are presented on FIG. 8.

### Experiment 7:

Protein attachment and biotin-streptavidin attachment reaction on glass slides derivatized with azidotrimethylsilane.

### Description of the Method:

The method is used to test for both the protein (antibodies) attachment to the azide-group-derivatized glass surface and its retention, and the efficiency of SAPE (phycoerythrin-labeled streptavidin) binding to the biotinylated anti-streptavidin antibodies. The biotinylated anti-streptavidin antibodies were attached onto glass slides by micro-deposition of 0.25 microliters of each of the following antibodies solutions: 1 mg/ml in PBS, 10× diluted solution, and 100× diluted solution as shown from the top to bottom on the slide images (to the Left) of FIG. 9. The top image represents phycoerythrin-(fluorescent-dye) labeled SAPE bound to unwashed Biotinylated anti-streptavidin antibodies and the bottom image represents the binding to the washed slides. The actual images are the vertical ones to the left and the 3-D graphic distribution of the signal is shown to the right of each slide image. Protein binding reactions on the slides were performed according to the Affymetrix GeneChip manual (edition 2002). Scans of the fluorescent signal we performed immediately after (control; shown at the top-section of FIG. 9) and again after washing the nonspecific-binding signal (shown at the bottom-section of FIG. 9) by the protocol within the same manual.

Experimental Result and Conclusion: Although the FIG. 9 represents only the result from protein attachment of slides derivatized with azidotrimethylsilane, another set of experiments was performed on iodotrimethylsilane-derivatized slides. Both surfaces performed almost identically well, however the azidotrimethylsilane seems to be of preferred choice for protein attachment. The attachment is as strong and reproducible as the attachment of oligonucleotides was found to be in the above test experiments.

We found that the surface hydrophobicity had much less impact on the protein deposition than on oligonucleotide one, probably due to the fact that the proteins had much higher molecular weight. Depositing larger nucleic acid molecules instead of short oligonucleotides may reveal the similar outcome. Combinations of more than one derivatization silanes will probably be more beneficent due to coupling properties.

### Experiment 8:

Testing surface repellency on different commercially important materials treated with surfacing mixtures.

At last, variety of commercially valuable materials were tested for their penetration and impregnation-ability while treated with different silane mixtures. A small representation pick of all performed tests is shown on FIG. 10. All the materials pictured on FIG. 10 were submersed for 10 minutes in 3% mixture solution in toluol (toluene), dried and probed with water to reveal the extend of impregnation by the water-repellency of the resulting surfaces. Beside the solution mixes identical to those described in regard to FIG. 3, in this test experiment were tested 30 more silane combinations, all proved to be an outstanding approach for surface derivatization and material entrapment almost uninfluenced by the type of the material and the size of the pore gaps.

The above described test-experiments well support the main claims of the invention giving the preference of combining variety of pre-manufactured compounds possessing specific properties and combining them with ones having highly-reactive chemical residues capable of polymerizing and forming thin layers with pre-designed thickness and properties matching specific practical needs. Since the demand for impregnation- and surfacing layers is growing over the years, this invention may be considered of high importance in wide industrial, scientific and medical area of application.

The embodiments of the invention in which an exclusive property or privilege is claimed are defined as follows:

1. Variable chemical compositions in a form of solutions, mixtures, suspensions or gels said composition containing combinations of any one-, two or more of the following components, where the existence of a Component Type-1 is obligatory:
(Components Type-1), from 0.001% to 99,999% by volume of a silane, siloxane, organo-silane (carbon-silane) or hydro-carbon including substituted 1, 2, 3, or 4 of the following—highly-reactive halogen atoms (such as F [fluorine], Cl [chlorine], I [iodine] and Br [bromine]) and/or the following reactive chemical groups: azido-, acetylene-, mercapto-, sulfonate-, thiol-, methoxy-, methacryloxy-—at any particular single atom of one-, more- or all silicone- (Si) and/or carbon-(C) atoms of the substituted molecule of compound Type-1, i.e. from one up to four substitutions may be present at at-least one silicone- or carbon atom, however as maximum as all silicone atoms in a particular substituted molecule may be substituted with halogen atoms or the mentioned reactive chemical groups as a matter of particular choice according to the general chemistry principles and depending upon particular applications—the chemical formula for the substituted silanes used as a Components Type-1 being schematically represented by Xₙ—[Sil]—Rₘ, where “R” is a hydrocarbon group (preferably alkyl-, aryl- or else); the reactive chemical group (atom) is represented by “X”, where “X”-substitution represents any of the following chemical groups—halogen-, azido-, acetylene-, mercapto-, sulfonate-, thiol-, methoxy-, methacryloxy-; “n” and “m” corresponds to the total number of substitutions containing “n”-count reactive groups (atoms) and “m”-count hydrocarbons (alkyl-, aryl-, alicyclic- or else groups), “[Sil]” in the formula stands for “silane” in which one or more silicone (Si) atoms are present within the silane molecule and each of them may contain chemical group substitution;
(Components Type-2), (applicable but not obligatory) is used in final concentrations from 0.001% to 99,999% by volume of cyclic-silane, -siloxane, -hydrocarbon and/or their cyclic derivatives—substituted or not—by halogen atom(s);
Components Type-3, used in final concentrations from 0.001% to 99,999% by volume, which may be utilized as applicable but not obligatory, being any other chemical and/or physical substance exhibiting certain desired or bi-functional molecular properties, and/or exhibits high affinity to react with and substitute a halogen- and/or other element from the silane molecule (some, but not only, examples of the latest being —H, —OH, C═C, C≡C, Metal-containing molecules and else) and/or so-called composite carriers—preferred nano(micro)-layer composite carriers that are relatively insoluble in the engulfing (surrounding) medium, being substances having hydroxyl- or else chemical groups on their surface capable of reacting in a strong manner with the Compound-1 silanes creating nanolayer composites.

2. Variable chemical compositions (mixtures and solutions) of claim 1 for surface derivatization designed and utilized as containing predominantly silicone- (Si), hydrogen-, oxygen, and other gaseous-elements atoms not interfering with the optical clarity property of the resulting polymeric layers intended for applications and surfacing agents in virtually all optical devices and optical industries utilized to reduce the light diffraction and/or to create molecular light channeling effects including but not limited to optical surface-masking and other surface effects by optically modifying or hiding surface colors and imperfections, cloaking, internal illumination, light dispersion and enhancement (shining), etc.

3. Variable chemical compositions (mixtures and solutions) of claim 1 for surface derivatization, which are designed and utilized as containing predominantly silicone- (Si), hydrogen-, oxygen, and other gaseous-elements atoms not interfering with the optical-clarity property of the resulting polymeric layers, and are also intended for creating desired optical properties on the targeted surfaces after being applied onto—including but not limited to high optical clarity, optical transparency, altered or modulated optical transparency and/or light-channeling properties.

4. The molecular positioning, the type and the total number of halogen-substitution atoms and the other substitution atoms and molecules within each monomer molecule of Components Type-1 and Components Type-2 of claim-1 are utilized to design the properties of the surfacing/impregnation layer formation as follows:
when containing only a single halogen- (and/or other chemically-volatile) atom within each —Si—Si—, —Si—C— or —C—C— monomer-molecule chain, the monomer molecule is used for polymerization “capping” (termination) and for creating a reduced- or limited-size, mostly “two-dimensional” (flat), surfaces since these single-substitution molecules are not able to support significant monomer polymerization within the all-components-containing mixtures;
when containing two halogen- (and/or other chemically-volatile) atoms within each —Si—Si—, —Si—C— or —C—C— monomer molecule, the mixtures (solutions) are designed to facilitate the formation of large-scale predominantly 2-dimensional polymerization surfacing layers with preferred polymerization growth in one dimension resulting in a larger-area “flat”-type layer with relatively limited surface thickness (i.e. limited 3-dimension thickness);
when containing 3 or more reactive substitutions (halogen atoms or other chemically-volatile atoms or groups described in claim 1) within each —Si—Si—, —Si—C— or —C—C— monomer molecule, the mixtures (solutions) are designed to facilitate the formation of large-scale 3-dimensional polymerization surfacing layers with expanded polymerization growth in all dimensions that (growth) is limited only by the chemical design and the concentration proportions of the Components Type-1 and -2, the gravity of the surfacing solution (mixture) and/or the surface- and capillary-tension forces, as well as any random factors that may play role in the final hydrophobic surface formation;
alternatively, the utilization of cyclic molecules of monomer compounds (Components Type-2 of claim 1) is to allow for creating higher nanolayer densities with enhanced (water- or oil-) repellant properties and, when non- or single-substituted by reactive groups,—a preferable layer growth in one dimension; i.e. enhanced 2-dimensional polymer growth—in parallel of the surface applied on, rather than equal growth in all 3 dimensions.

5. The Components Type-1 of claim 1, schematically represented by Xₙ—[Sil]—Rₘ, where “R” is a hydrocarbon group (preferably but not limited to alkyl- or aryl-grout) that comprise a chain of carbon (C-) atoms including from 1 to 200 carbon atoms per R-radical, such as methyl-, ethyl-, n-propyl-, isopropyl-, n-butyl-, sec-butyl-, decyl-, dodecyl-, tetradecyl-, hexadecyl-, octadecyl-, etc. radicals; aryl groups represented by R are phenyl- and toloyl radicals or else; alicyclic groups represented by “R”, which are free of heteroatoms as constituents of the ring are —(CH₂)₅— and —(CH₂)₄— radicals, and an example of alicyclic groups represented by “R” which have a heteroatom as a constituent of the ring is a —(CH₂)₂—O—(CH₂)₂— radical; the methyl-radical is a preferred example of an alkyl group represented by “R”; the silanes groups [Sil] included may have any chemical structure and the preferably utilized are the ones containing from 1 to 300 silicone atoms within a single silane-, siloxane and/or carbon-silane (organosilane) monomer molecule for both Components Type-1 and Components Type-2.

6. A method for assembling nano-coating and derivatization solutions and mixtures, said method comprising the essential approach of combining (pre-mixing) at ambient conditions any of one-, two- and/or multi-component solutions containing silanes, cyclic molecular compounds (silanes, hydrocarbons, silane-carbons and their derivatives) and other monomer-type molecular components (existing as separate molecular substances or as molecular substitutes within the silanes and/or the cyclic compound molecules) being utilized as a single-type chemical substances—in a pure- or diluted form;
thus the method process includes the approach of initial molecular distribution and interactions of all the monomer-type components (halogenated- or substituted with other-type highly-reactive chemical groups such as azido-, acetylene-, mercapto-, sulfonate-, thiol-, methoxy-, methacryloxy- and/or cyclic molecular compounds) in the pre-mixes and the absorption (adherence) capabilities of the Si-atom, which all further contribute to the surface attachment formation of the ultra-thin (nano-)layers bearing desired and designed properties;
said method itself utilize random and spontaneous reaction of the combined monomer molecular substance with the (organo)halogen-silanes and with water (hydrolysis) [and/or solvent-alcohol(s), and/or other hydroxyl-group-bearing compounds when used] resulting in variety of chemical products some of which produce silanols, which, using or not HCl- or else catalysis, lead directly to further reacted oligomers or polymer siloxanes completing the repellant layer formation via directed- (designed-) and/or random chemical reactions finally resulting in a two- or three-dimensional formation of ultrathin layers upon surface-application;
said method and approach comprises high (design) flexibility for coating- and derivatization-mixtures preparation in achieving both highly flexible-upon-design properties for specific surface/environment applications and for the preparation of other subsequent types of surfacing and/or impregnation derivatization solutions (mixes) by the means of strong covalent (permanent) bonding.

7. The method for assembling surfacing solutions and mixtures of claim 6 includes the approach of varying the molecular ratios of the 1-, 2-, 3- or 4-reactive atom- and/or chemical-group-substituted silanes (at a particular single silicone-atom and/or anywhere within the monomeric molecule) within each particular composed derivatization solution (mixture), which approach allows for controlling and flexibly adjusting the thickness, and the density of the created nanolayers—thereby the higher the molecular ratios of the halogen-substituted silanes are within the mixture, the higher is the thickness and the density of the resulting nanolayer formation; the longer the hydrocarbon- (or other hydrophobic-) molecular chains of the substitutions at each silicone (Si) atom is—the higher is the thickness and the density of the resulting nanolayer and, respectively, the greater is the repellency; the higher is the molecular ratio of the halogen elements, especially the fluorine, the higher is the oil-repellency of the surfacing layer created.

8. The method for assembling surfacing solutions and mixtures of claim 6 includes the approach of adjusting the design of the final surfacing layer created to fulfill certain specific surface properties and requirements as well as flexibility for adjusting to specific applications by creating high variety of combinatory mixes of reactive-chemical substituted silanes with other silanes, siloxanes, hydrocarbons and another organic and/or inorganic compounds exhibiting repellent properties in which both commercially available- and specifically-synthesized monomer compounds are used—highly efficient thin surfaces are produced for attachment and derizatization of chemicals, and miniature mechanical components and devices when the solutions (mixtures) are deposited as surfacing layer(s)—i.e. the design flexibility is achieved by varying the type-, the number, and the molecular proportions of the combined monomer compounds within the solutions (mixtures).

9. The method for derivatization solutions and mixtures of claim 6 is performed at ambient values of temperatures, visible-light or dark-light conditions and atmosphere humidity since it is relatively tolerant to the conditions in general; however, due to the very-high chemical reactivity of the halogen-element-substituted chemical compounds, the preferences for these ambient conditions are to be at their low-energy levels—such as: temperatures from −50° C. to 50° C.; lighting below the visible- or the visible of above 450 nm wave-length (but below the UV-spectrum) with low luminosity; atmospheric air composition, preferably with low oxygen- and high argon content; lowest possible atmosphere humidity, preferably below 30%; otherwise the high-range values are preferable for the above conditions after the surface application of the composed mixtures is performed—i.e. the hydrophobic layer surface-formation is enhanced at higher temperatures (up to 500° C.), light within the UV spectrum (200-450 nm) with moderate luminosity, and high air humidity with water molecules present up to 90% (v/v); with such a derivatization method performed with manipulations such as, but not limited to: mixing, spraying, whipping, evaporation, vacuumization, immersion, etc.

10. The method for assembling surfacing solutions and mixtures comprise silicone-containing monomeric chemical substances capable of polymerizing based upon substitution-type chemical reactions utilizing chemical atom- and/or chemical-group substitutions within their monomeric molecule such as—highly-reactive halogen atoms (preferably F [fluorine], Cl [chlorine], I [iodine] and Br [bromine]) and/or prefferably the following reactive chemical groups: azido-, acetylene-, mercapto-, sulfonate-, thiol-, methoxy-, methacryloxy-) is specifically intended for surface deposition, attachment, encapsulation and/or impregnation by the means of a formation of two- or three-dimensional nano-(micro-)layers as a result of molecular cross-linking between the components of the mixed compounds (silicone-, carbon-, etc., compounds) and the surface components; thereby the attachment composition mixtures under this invention are also intended for usage in the derivatization of surfaces with displaying chemically-reactive groups for a consecutive attachment of tissues, cells, biomolecules, pharmaceutical agents, membranes, filters, porous matrices and/or other components, and/or micro-devices serving for detection, and/or energy-delivering and energy-transferring purposes, and for microencapsulation/impregnation of small objects of biological and/or mechanical nature, and/or for their attachment to surfaces by the means of the silicone nano-(micro-) layers and covalent bonds formed.
